(19) United States
(12) Patent Application Publication
(10) Pub. No.: US 2013/0299460 A1
(43) Pub. Date: Nov. 14, 2013

(54) HARDFACING SUBMERGED ARC WELDING DEVICE

(71) Applicant: NATIONAL CHUNG -HSING UNIVERSITY, Taichung City (TW)

(72) Inventors: Wei-Te WU, Tainan City (TW); Hsuan-Han LAI, Taichung City (TW); Li-Yin KUO, Taichung City (TW); Chia-Hsien Li, Taichung City (TW); I-Chin CHOU, Taichung City (TW); Chia-Ming CHANG, Taichung City (TW); Shun-Pao SHIH, Taichung City (TW)

(73) Assignee: National Chung -Hsing University, Taichung City (TW)

(21) Appl. No.: 13/801,284

(22) Filed: Mar. 13, 2013

(30) Foreign Application Priority Data
May 14, 2012 (TW) 101117096

(51) Int. Cl. B23K 9/00

(52) U.S. Cl. CPC B23K 9/0061
USPC 219/72

(57) ABSTRACT

A hardfacing submerged arc welding device includes an alloy-powder supplying unit for supplying alloy powders onto a workpiece, a flux-powder supplying unit for supplying flux powders onto the workpiece, and a welding-wire supplying unit for supplying a welding wire onto the workpiece.

### CROSS-REFERENCE TO RELATED APPLICATION

This application claims priority of Taiwanese Application No. 101117096, filed on May 14, 2012.

### BACKGROUND OF THE INVENTION

1. Field of the Invention

This invention relates to a welding device, and more particularly to a hardfacing submerged arc welding device for forming a hardfacing layer on a surface of a workpiece.

2. Description of the Related Art

Referring to FIG. 1, a conventional hardfacing welding process includes moving a welding wire 11 onto a surface 121 of a workpiece 12 and melting the welding wire 11, e.g., by gas tungsten arc welding (GTAW) technique to form an alloy hardfacing layer.

Such a welding process is suitable for workpieces having a small area to be formed with a hardfacing layer. If the area of the workpiece to be formed with the hardfacing layer is relatively large, the time and costs required for forming the hardfacing layer in the above-mentioned manner will be increased significantly.

### SUMMARY OF THE INVENTION

The object of this invention is to provide a hardfacing submerged arc welding device that is efficient and cost-effective.

According to this invention, a submerged arc welding device is adapted to form a hardfacing layer on a surface of a workpiece. The submerged arc welding device includes:
an alloy supplying unit including a first tank adapted for storing alloy powders, and a first tube assembly connected to the first tank and adapted for guiding the alloy powders to drop onto the surface of the workpiece;
a flux-powder supplying unit including a second tank adapted for storing flux powders, and a second tube assembly adapted for guiding the flux powders to drop onto the surface of the workpiece; and
a welding-wire supplying unit including a reel adapted for permitting a welding wire to be wound thereon, and a delivery mechanism adapted for guiding the welding wire to move onto the surface of the workpiece.

### BRIEF DESCRIPTION OF THE DRAWINGS

These and other features and advantages of this invention will become apparent in the following detailed description of a preferred embodiment of this invention, with reference to the accompanying drawings, in which:

FIG. 1 is a schematic view illustrating a conventional hardfacing submerged arc welding process;

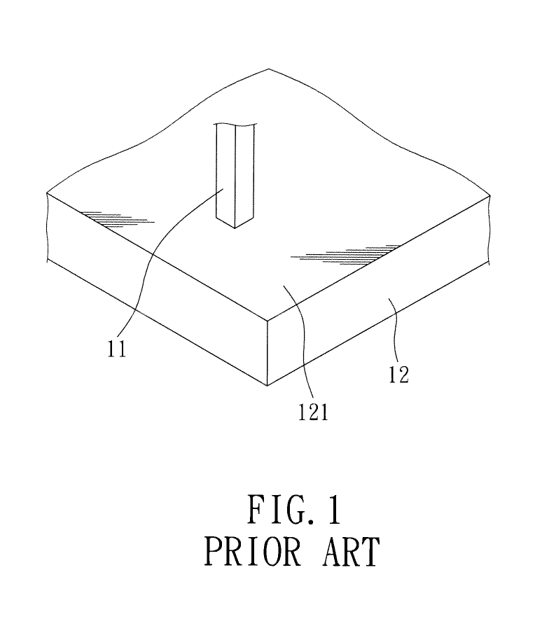

FIG. 2 is a perspective view of the preferred embodiment of a hardfacing submerged arc welding device according to this invention; and

FIG. 3 is a schematic view illustrating a welding process of the preferred embodiment.

### DETAILED DESCRIPTION OF THE PREFERRED EMBODIMENT

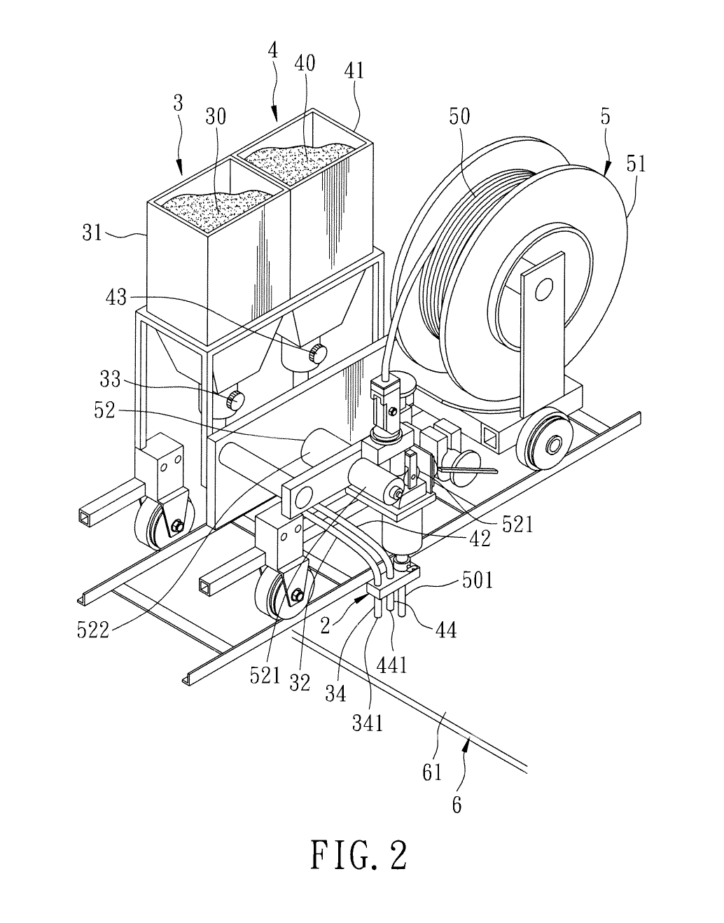

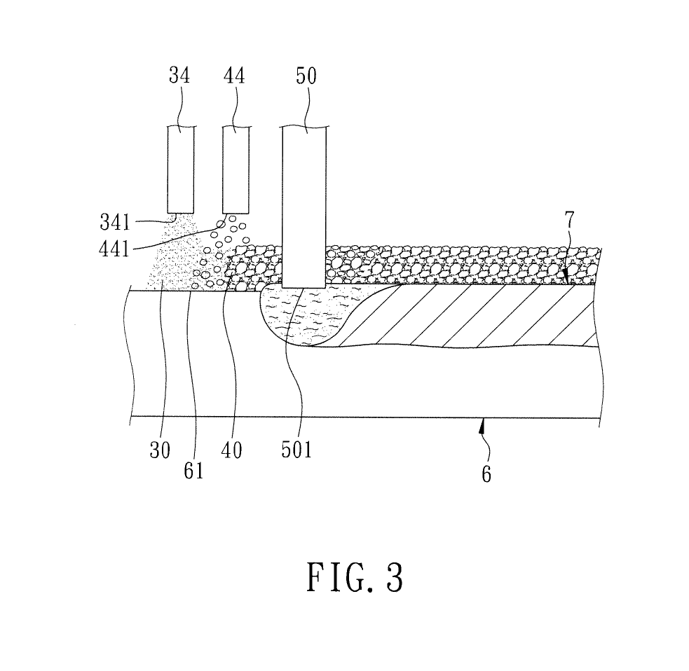

Referring to FIGS. 2 and 3, the preferred embodiment of a hardfacing submerged arc welding device according to this invention includes a support 2, an alloy-powder supplying unit 3, a flux-powder supplying unit 4, and a welding-wire supplying unit 5.

The alloy-powder supplying unit 3 includes a first tank 31 for storing alloy powders 30, a generally horizontal first tube 32 connected to the first tank 31, a first adjuster 33 interconnecting the first tank 31 and an end of the first tube 32 and operable for adjusting the output amount of the alloy powders 30, and a vertical first nozzle 34 extending through the support 2 and connected to an opposite end of the first tube 32. The first tube 32 cooperates with the first nozzle 34 to constitute a first tube assembly. The first nozzle 34 has a first nozzle opening 341 permitting the alloy powders 30 to drop from the first nozzle 34 therethrough.

The flux supplying unit 4 includes a second tank 41 for storing flux powders 40, a generally horizontal second tube 42 connected to the second tank 41, a second adjuster 43 interconnecting the second tank 41 and an end of the second tube 42 and operable for adjusting the output amount of the flux powders 40, and a vertical second nozzle 44 extending through the support 2 and connected to an opposite end of the second tube 42. The second tube 42 cooperates with the second nozzle 44 to constitute a second tube assembly. The second nozzle 44 is disposed behind the first nozzle 34, and has a second nozzle opening 441 permitting the flux powders 40 to drop from the second nozzle 44 therethrough.

The welding-wire supplying unit 5 includes a reel 51 permitting a welding wire 50 to be wound thereon, and a delivery mechanism 52 for guiding the welding wire 50 to move through the support 2. The welding wire 50 has a vertical filler end portion 501 disposed under the support 2. The delivery mechanism 52 includes a pair of rollers 521 for driving the welding wire 50 to move away from the reel 52, and a motor 522 for driving rotation of one of the rollers 521. The filler end portion 501 of the welding wire 50 is disposed behind the second nozzle 44, so that the filler end portion 501 of the welding wire 50, the first nozzle 34, and the second barrel 44 are aligned along a front-to-rear direction.

During a hardfacing submerged arc welding process performed on a surface 61 of a workpiece 6, which is disposed under the first and second nozzles 34, 44, the alloy powders 30 stored in the first tank 31 are guided by the first tube 32 to drop from the first nozzle opening 341 of the first nozzle 34 onto the surface 61 of the workpiece 6, the flux powders 40 stored in the second tank 41 are guided by the second tube 42 to drop from the second nozzle opening 441 of the second nozzle 44 onto the surface 61 of the workpiece 6, and the rollers 521 are driven by the motor 522 to move the welding wire 50 through the support 2 and corresponding ones of the flux powders 40 deposited on the surface 61 of the workpiece 6 to contact the alloy powders 30, so that the filler end portion 501 of the welding wire 50 is adjacent to the surface 61 of the workpiece 6. It should be noted that, the hardfacing submerged arc welding device is moved relative to the workpiece 6 in a direction during the welding process.

As such, the welding-wire supplying unit 5 and the alloy-powder supplying unit 3 can supply continuously the welding wire 50 and the alloy powders 30 to form quickly a hardfacing layer 7 on the surface 61 of the workpiece 6, such that the flux powders 40 cover the surface 61 of the workpiece 6 to protect the molten metal from air.

It should also be noted that, conventional submerged arc welding is a high heat input welding, which can increase the welding efficiency. However, an increase in the heat input results in a reduction in the impact toughness of the welded joint. Therefore, preferably, the welding wire 50 is designed and the alloy powders 30 are selected according to the material characteristics of the workpiece 6, so that the alloy hardfacing layer 7 can have the advantages of sufficient hardness, high impact toughness, high wear resistance, high corrosion resistance, and high temperature oxidation resistance.

The alloy-powder supplying unit 3 and the flux-powder supplying unit 4 can be mounted on conventional submerged arc welding equipment, and can provide a high-efficiency filling. Table 1 illustrates that, during a submerged arc welding process in the same condition, the filling efficiency of conventional equipment is only 97.6%, and the filling efficiency of this invention is up to 131.1%. this proves that the surface treatment efficiency of the submerged arc welding process is improved by use of the device of this invention.

TABLE 1

| | Conventional | This |
|---|---|---|
| Experimental item | equipment | invention |
| The original weight | 0.846 | 0.866 |
| of welding wire 40 (Kg): A | | |
| The weight of welding | 0.804 | 0.821 |
| Wire 40 after welding (Kg): B | | |
| Consumed amount of | 0.042 | 0.045 |
| Welding wire 40 (Kg): C = A − B | | |
| The original weight | 5.121 | 5.108 |
| Of workpiece 6 (Kg): D | | |
| The weight of Workpiece | 5.162 | 5.167 |
| after welding (Kg): E | | |
| The weight of hardfacing | 0.041 | 0.059 |
| Layer 7 (Kg): G = E − D | | |
| Filling efficiency: G/C | 97.6% | 131.1% |

As illustrated in Table 1, the hardfacing submerged arc welding device of this invention has the following advantages:

1. Through operation of the alloy-powder supplying unit 3, the flux-powder supplying unit 4, and the wire supplying unit 5, the alloy powders 30, the flux powders 40, and the welding wire 50 can be supplied at different times. As such, the welding wire 50 can be designed, and the alloy powders 30 can be selected according to the material characteristics of the workpiece 6, so as to increase largely the filling efficiency. Hence, the input heat can be reduced, so that sufficient impact toughness of the welded joint can be obtained. Consequently, the hardfacing layer 7 can have a relatively large area to be formed with the hardfacing layer 7, and the requirement of maintenance and repair of the workpiece 6 can be reduced.

2. The alloy-powder supplying unit 3, the flux-powder supplying unit 4, and the welding-wire supplying unit 5 can be mounted on conventional submerged arc welding equipment, thereby promoting the flexibility during use, and reducing the manufacturing costs.

With this invention thus explained, it is apparent that numerous modifications and variations can be made without departing from the scope and spirit of this invention. It is therefore intended that this invention be limited only as indicated by the appended claims.

We claim:

1. A submerged arc welding device adapted to form a hardfacing layer on a surface of a workpiece, said submerged arc welding device comprising:
an alloy supplying unit including a first tank adapted for storing alloy powders, and a first tube assembly connected to said first tank and adapted for guiding the alloy powders to drop onto the surface of the workpiece;
a flux-powder supplying unit including a second tank adapted for storing flux powders, and a second tube assembly adapted for guiding the flux powders to drop onto the surface of the workpiece; and
a welding-wire supplying unit including a reel adapted for permitting a welding wire to be wound thereon, and a delivery mechanism adapted for guiding the welding wire to move onto the surface of the workpiece.

2. The submerged arc welding device as claimed in claim 1, further comprising a support, the first tube assembly including a first tube extending through said support and connected to said first tank at an end thereof, and a vertical first nozzle connected to an opposite end of said first tube and adapted to be disposed directly above the surface of the workpiece.

3. The submerged arc welding device as claimed in claim 2, wherein the second tube assembly includes a second tube connected to the second tank at an end thereof, and a vertical second nozzle extending through said support and connected to an opposite end of said second tube and adapted to be disposed directly above the surface of the workpiece.

4. The submerged arc welding device as claimed in claim 3, the welding wire having a vertical filler end portion adjacent to the surface of the workpiece, wherein said first nozzle and said second nozzle are adapted to be aligned with the filler end portion, in such a manner that said second nozzle is disposed between said first nozzle and the filler end portion of the welding wire.

5. The submerged arc welding device as claimed in claim 1, wherein the delivery mechanism includes a pair of rollers adapted for driving the welding wire to move away from said reel, and a motor for driving rotation of one of said rollers.

6. The submerged arc welding device as claimed in claim 1, wherein said alloy-powder supplying unit further includes an adjuster interconnecting said first tank and said first tube and operable to adjust the output amount of the alloy powders dropping from said first nozzle.

7. The submerged arc welding device as claimed in claim 1, wherein said flux-powder supplying unit further includes an adjuster interconnecting said second tank and said second tube and operable to adjust the output amount of the flux powders dripping from said second nozzle.
